(19) United States
(12) Patent Application Publication
(10) Pub. No.: US 2021/0269928 A1
(43) Pub. Date: Sep. 2, 2021

(54) Hydrogen Generating Device

(71) Applicant: Angelo Agro, Anderlecht (BE)

(72) Inventor: Angelo Agro, Anderlecht (BE)

(21) Appl. No.: 17/259,043

(22) PCT Filed: Jul. 8, 2019
(86) PCT No.: PCT/EP2019/068258

§ 371 Date: Jan. 8, 2021

(30) Foreign Application Priority Data
Jul. 9, 2018 (BE) BE2018/5480

(51) Int. Cl. C25B 1/04; C25B 15/08

(52) U.S. Cl. CPC C25B 1/04; C25B 15/08

(57) ABSTRACT

Example embodiments relate to a hydrogen-generating device. One embodiment includes a system. The system includes at least one device for reducing a fuel consumption of a vehicle. The device includes an enclosure. The device also includes an inlet for bringing a fluid into the device. Further, the device includes an outlet to release the fluid from the device. In addition, the device includes a plurality of conductive plates arranged in the enclosure so as to define compartments. Still further, the device includes alternating lower openings and upper openings arranged to allow a flow of a fluid between the inlet and the outlet. The lower openings are offset from the upper openings in a second direction perpendicular to the first direction so that, when the second direction is a vertical direction, when the fluid moves up in a compartment, the fluid moves down in the next compartment.

### TECHNICAL AREA

The present invention relates to a device for reducing the fuel consumption of a vehicle by generating hydrogen through the electrolysis of water.

### PRIOR ART

The document CA2708139A1 describes a device for generating hydrogen through the electrolysis of water. This device comprises a series of vertical plates parallel to one another. The plates delineate impermeable cells. The electrolysis of the water can be produced in each of these cells.

During the electrolysis, the water is converted into gaseous hydrogen and gaseous oxygen. Since these gases are lighter than the liquid water, they are preferentially placed at the top of the cells (as indicated on page 7 of this document), while the water is preferentially placed at the bottom of the cells as the electrolysis reaction continues. The electrolysis is then above all produced at the bottom of the cells, which makes the production of hydrogen diminish over the course of time. Furthermore, the device must be oversized in order to allow a production that remains at a sufficient rate, even with this reduction over the course of time.

The document U.S. Pat. No. 5,292,405 discloses an electrolysis cell.

The document US2009/166191 A1 discloses an apparatus for generating a gas by electrolysis.

The document U.S. Pat. No. 3,975,247 describes a system for the treatment of the wastes and recovery of the water and the usable solids.

The document GB365983 describes an apparatus for the electrolytic revitalization of the potassium ferrocyanide formed during the purification of the gasses by oxidation of hydrogen sulfide with potassium ferrocyanide.

### SUMMARY OF THE INVENTION

One of the objectives of the invention is to provide a device for generating hydrogen through the electrolysis of water with a less fluctuating rate and which is particularly compact and light. For this purpose, the invention proposes a device for reducing the fuel consumption of a vehicle and comprising:
An enclosure,
An entry to allow a fluid to enter into the device,
An exit to allow the fluid to exit from the device,
A multiplicity of conductive plates arranged in the enclosure in such a way as to delineate the compartments,
   with the multiplicity of plates comprising, in a first direction, a first end plate, intermediate plates, and a second end plate,
   with at least one of the plates being arranged to form an anode and at least one other of the plates being arranged to form a cathode,
   characterized in that, the device comprises lower openings and upper openings arranged in alternating form in order to permit a flow of fluid between the entry and the exit, with a passage of fluid between two successive compartments being possible only through one or several lower opening(s) or through one or several higher opening(s), with the lower openings being upper openings shifted in a second direction perpendicular to the first direction.

The device in accordance with the invention makes it possible to generate hydrogen. The hydrogen is then used in the vehicle as an agent for the improvement of the combustion in order to considerably improve the combustion yield of a hydrocarbon fuel. Inside the device in accordance with the invention, the fluid is forced to pass from one compartment to the other one between the entry and the exit of the enclosure. In order to pass from one compartment to the adjacent compartment, it must alternately pass through an opening “above” the plates and through an opening “below” the plates. Thus, it must carry out a vertical movement in the interior of the compartments, which prevents a separation between liquid and gas in the interior of the compartments. As the result, the entire surface of the plates between the lower opening and the higher opening of a compartment is used to carry out the electrolysis. This makes it possible to obtain a rate of production of hydrogen that is more stable than for the known devices.

The device in accordance with the invention is arranged in such a way as to force the fluid to make movements in the second direction: in one compartment, the fluid is displaced towards the top and, in the following compartment, it is displaced towards the bottom. In other words, one plate does not comprise lower and higher openings at the same time. Thus, the device in accordance with the invention is clearly distinguished from the device described in the document US2009/166191 A1, in which the plates comprise lower and higher openings at the same time.

The sole openings between the compartments are the lower or higher openings. One compartment is, preferably, delimited from a first side by a wall or plate having only one or several lower opening(s) and from a second side, opposite the first side in the first direction, by a wall or plate having only one or several higher opening(s). Each opening comprises at least one hole, such as a slot, for example.

The device in accordance with the invention makes it possible for all of the hydrogen produced to be used directly, because the device is portable. This therefore prevents the stockpiling of this particularly explosive gas.

The plates are preferentially spaced by a distance of one or two mm. The plates are preferentially rigid. Nevertheless, they could be flexible while still remaining within the framework of the present invention. The plates are preferentially level. Nevertheless, they could be curved while still remaining within the framework of the present invention. The plates are preferentially essentially parallel.

The fluid passing through the entry is an aqueous electrolytic solution. This can be one such as at least partially demineralized water, rain water, or an aqueous solution of NaOH, for example.

The device is arranged in such a way that the anode can be connected to a positive electrical potential and the cathode can be connected to a negative electrical potential.

Within the framework of the present document, “hydrogen” is the dihydrogen molecule. Within the framework of the present document, “oxygen” is the dioxygen molecule.

The entry preferably comprises an opening in the enclosure. The exit preferably comprises an opening in the enclosure.

The enclosure can be of polymethyl methacrylate, such as of plexiglass.

In one embodiment of the invention, the lower openings and the higher openings comprise holes passing through the intermediate plates.

In one embodiment of the invention, the lower openings and the higher openings comprise a hole passing through the first end plate and a hole passing through the second end plate.

In one embodiment of the invention, the first end plate is arranged to form an anode and the second end plate is arranged to form a cathode. They may be connected to an electrical power supply device, for example.

In one embodiment of the invention, the first end plate is arranged to form the anode and the second end plate is arranged to form the cathode and at least some of the intermediate plates are arranged to form a floating electrical potential.

In other words, in this embodiment, the intermediate plates are not connected with an external potential by means of a solid conductor.

In one embodiment of the invention, the lower openings and the higher openings are slots. The inventor has carried out tests and has observed that slots make a better yield possible than a series of holes. In fact, with equal opening surfaces, the effects of friction are reduced for a slot in relation to holes.

The slots preferably extend in a third direction perpendicular to the first and second directions.

Preferably, each of the plates comprises only one slot. This makes it possible to maximize the length of the contact between the fluid and the plates.

Preferably, the slots comprise between 70% and 95% of the width of a plate. The width of the plate is its extent in the third direction.

In one embodiment of the invention, at least two adjacent plates are made from the same material. This simplifies the manufacturing of the device and reduces its cost.

In one embodiment of the invention, the plates are metallic.

In one embodiment of the invention, the plates are made of stainless steel, and/or of platinum, and/or of gold.

In one embodiment of the invention, two consecutive plates are kept at a distance from one another by means of a joint or a spacer unit. The joint or the spacer unit is made from silicone or rubber, for example.

The invention, furthermore, proposes a system comprising:
At least one device in accordance with one embodiment of the invention,
A pump arranged to make a fluid circulate between the entry and the exit, and:
An electrical power supply device, one connected to the anode and one connected to the cathode.

The electrical power supply device preferably makes it possible, furthermore, to supply the pump with power.

In one embodiment of the invention, the system comprises a multiplicity of devices for generating hydrogen in accordance with the invention arranged in such a way as to be sequential. The exit of the first device in accordance with the invention is fluidically connected with the entry of the second device, and so on.

In one embodiment of the invention, the system furthermore comprises a combustion device and a means of fluidics flow connecting the exit to an entry of the combustion device.

Within the framework of the present document, a combustion device can be any device in which combustion is produced, preferably a combustion of a fossil fuel. This may be an internal combustion engine or a combustion boiler, for example.

The inventor has experimentally determined that a connection in front of the flow meter (or behind it, as the case may be) makes possible a reduction of 70% (or 90%, respectively) of the CO₂ emissions of the combustion device. The device in accordance with the invention also makes it possible to reduce the fuel consumption of the combustion device.

In one embodiment of the invention, the means of fluidics flow comprises a filtration device. This device makes it possible to prevent the water from being injected into the combustion device.

In one embodiment of the invention, the means of fluidics flow comprises an anti-return device. This device makes it possible to prevent any return of flames.

The invention, furthermore, proposes a vehicle comprising a device or a system in accordance with the invention. The device is installed in the vehicle in such a way that the second direction is a vertical direction.

The invention, furthermore, proposes a method for generating hydrogen comprising the steps of:
(a) Supplying a device, a system or a vehicle in accordance with the invention,
(b) Supplying fluid to the entry of the device and making the fluid circulate between the entry and the exit of the device, and
(c) Applying a difference in potential between the anode and the cathode.

The advantages stated for the device are applied to the method in the manner of mutatis mutandis.

### BRIEF DESCRIPTION OF THE FIGURES

Other characters and advantages of the invention will appear from the reading of the detailed description which is provided in the following for the understanding of what will be stated in connection with the attached figures, among which:

FIG. 1 is a lateral section of a device in accordance with a first embodiment of the invention;

FIG. 2 is a lateral section of a device in accordance with a second embodiment of the invention;

FIG. 3 is a lateral section of a device in accordance with a third embodiment of the invention;

FIG. 4a is a frontal view of a plate 20 used in one embodiment of the device;

FIG. 4b is a frontal view of a plate 20 used in one embodiment of the device;

FIG. 5a is a frontal view of a plate 20 used in one embodiment of the device;

FIG. 5b is a frontal view of a plate 20 used in one embodiment of the device; and

FIG. 6 is a schematic depicting one embodiment of a system in accordance with the invention.

### EMBODIMENTS OF THE INVENTION

The present invention is described with specific embodiments and references to the figures, but the invention is not limited to these. The diagrams or figures described are only schematic and are not limiting.

In the figures, identical or analogous elements may bear the same reference numbers.

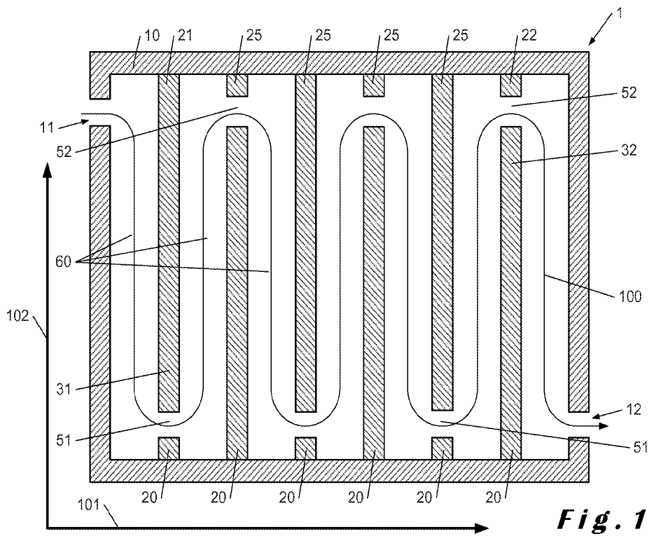

FIG. 1 depicts a cross-sectional view, in a vertical plane, of a device 1 for generating hydrogen in accordance with one embodiment of the invention.

FIG. 1 makes it possible to visualize one preferred possibility for a first direction 101 and a second direction 102 perpendicular to the first direction 101. The first direction 101 corresponds to the overall movement of a fluid in the device 1. It is preferably horizontal. The second direction 102 is preferably vertical.

The device 1 comprises an enclosure 10, with an entry 11 making it possible to make fluid enter into the enclosure 10 and an exit making it possible to make the fluid exit from the enclosure 10. The device 1 is arranged in such a way as to conduct the fluid between the entry 11 and the exit 12.

The device 1 comprises plates 20 in the interior of the enclosure 10. They are preferably vertical. They are preferably fixed to the enclosure 10. The plates 20 are preferably perpendicular to the first direction 101 and are spaced in this direction. The plates 20 follow one another in the first direction 101 in the following order:
A first end plate 21,
A multiplicity of intermediate plates 25, and
A second end plate 22.

The plates 20 divide at least a portion of the enclosure 10 into compartments 60. The compartments 60 are fluidically connected between themselves only by way of lower openings 51 and upper openings 52. The lower openings 51 and higher openings 52 make possible a flow of fluid 100 between the entry 11 and the exit 12.

The lower openings 51 are spatially shifted in the second direction 102 in relation to the higher openings 52. Thus, the higher openings 52 are higher than the lower openings 51.

The fluid being displaced in the device 1 passes from one compartment 60 to the other by alternately passing through at least one lower opening 51 and at least one higher opening 52. In other words, the flow of fluid 100 in the interior of the device 1 has a rising and a descending form, such as a sinusoidal form or a serpentine form. A passage of fluid between two successive compartments is possible only through one or several lower opening(s) or through one or several higher opening(s), but not through one or several lower opening(s) and through one or several higher opening(s) at the same time.

During its fluidic flow 100 in the device 1, the fluid undergoes an electrolysis reaction that is at least partially converted chemically and which at least partially changes phase. At the entry 11, the fluid is essentially an aqueous liquid solution. At the exit 12, the fluid comprises gaseous hydrogen and oxygen. Between the entry 11 and the exit 12, the fluid comprises a mixture of liquid and of gas.

The exit 12 could comprise a multiplicity of passages, such as a first passage arranged to allow the liquid portion of the fluid to exit and a second passage arranged to allow the gaseous portion of the fluid to exit.

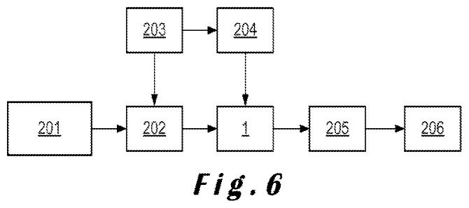

The plates 20 are capable of conducting electricity. At least one of the plates is arranged to form an anode 31 and at least one of the plates is arranged to form a cathode 32. The anode 31 and the cathode 32 are arranged in order to be connected to an electrical power supply device 203 (FIG. 6).

Preferably, the first end plate 21 or the second end plate 22 forms the anode and the other of these two plates forms the cathode. Preferably, at least some of the intermediate plates 25 are arranged to form a floating electrical potential. Thus, the electrical potential of the intermediate plates 25 is determined by the ambient conditions and, in particular, the potentials of the first end plate 21 and the second end plate 22.

Preferably, all the plates 20 are made from the same material. Specifically, two consecutive plates are preferably made from the same material. This material is preferentially a metal, such as of stainless steel.

Preferably, the plates 20 are separated from one another by joints or spacer units (not depicted) located close to the connections of the plates 20 to the enclosure 10.

A joint (not depicted) can also be present at the junction between each plate and the enclosure in order to ensure the tightening of this junction.

FIG. 1 depicts one embodiment of the device 1, in which the lower openings 51 and the higher openings 52 comprise holes passing through the intermediate plates 25, with at least one hole passing through the first end plate 21 and at least one hole passing through the second end plate 22.

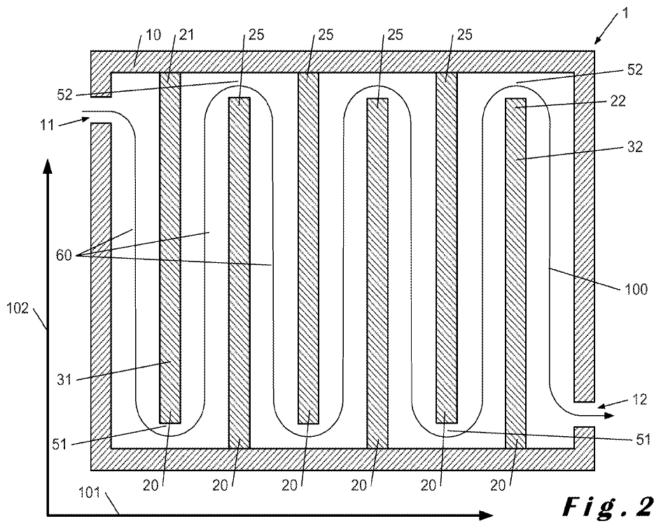

FIG. 2 depicts one embodiment of the device 1 in which the lower openings 51 and the higher openings 52 comprise holes between the plates 20 and the enclosure 10.

FIG. 3 depicts one embodiment of the device 1 in which the lower openings 51 and the higher openings 52 comprise holes passing through the intermediate plates 25, and in which the first end plate 21 and the second end plate 22 are hermetically sealed.

As depicted in FIGS. 1 to 3, it is preferable that the entry 11 is shifted in the second direction 102 in relation to the first opening. It is, furthermore, preferable that the exit 12 is shifted in the second direction 102 in relation to the last opening.

It is possible, while still remaining within the framework of the invention, for the multiplicity of plates to be comprised in the following order:
The first end plate 21, which forms a first anode 31,
Intermediate plates 25 with a floating electrical potential,
An intermediate plate 25, which forms a first cathode 32,
Intermediate plates 25 with a floating electrical potential,
An intermediate plate 25, which forms a second anode 31,
Intermediate plates 25 with a floating electrical potential,
Potentially other plates, and
The second end plate 22, which forms an “n-th” cathode 32.

Within the framework of the present invention, the respective positions of the anode and of the cathode may be reversed.

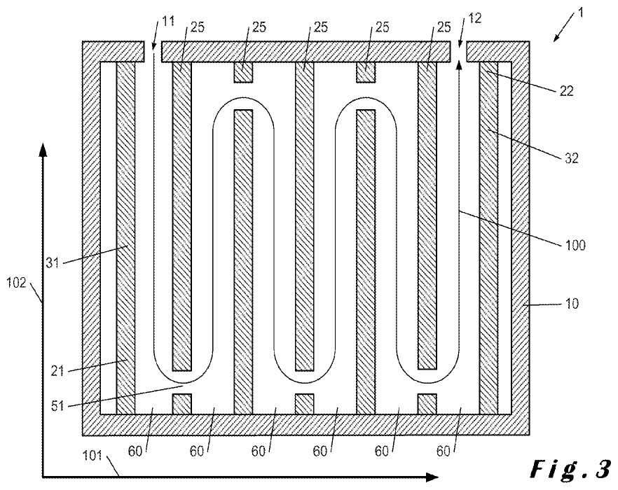

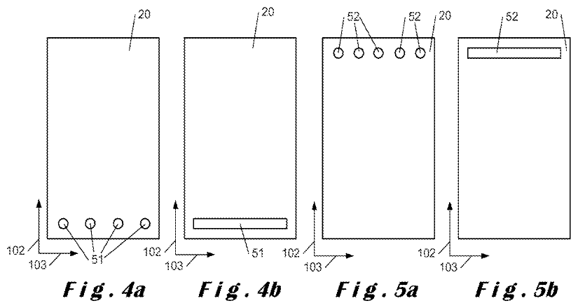

FIG. 4a is a frontal view of a plate 20 comprising circular holes which form lower openings 51.

FIG. 4b is a frontal view of a plate 20 comprising a slot, which forms a lower opening 51. The plate 20 comprises only one slot. The slot extends in a third direction 103 that is perpendicular to the first 101 and to the second 102 direction.

FIG. 5a is a frontal view of a plate 20 comprising of the circular holes that form upper openings 52.

FIG. 5b is a frontal view of a plate 20 comprising a slot, which forms a higher opening 52. The plate 20 comprises only one slot. The slot extends in the third direction 103.

FIG. 6 is a schematic depicting one embodiment of a system in accordance with the invention. The system comprises one or several device(s) 1 for generating hydrogen in accordance with the invention, a reservoir of fluid 201 and a pump 202 making the fluid circulate from the reservoir 201 towards the device 1, in the device 1, and downstream from the device 1. The system comprises, furthermore, an electrical power supply device 203 supplying the pump 202 and the device 1 for generating hydrogen. Preferably, the electrical power supply device 1 is controlled by a controller 204 that makes it possible to regulate the production of hydrogen, such as the current between the electrodes and/or the potential to the electrodes. The electrical power supply device 203 is connected to the anode 31 and to the cathode 32 of the device 1.

The system furthermore preferably comprises a combustion device 206, one entry of which is connected by means of fluidics flow to the exit 12 of the device 1 for generating hydrogen.

This means of fluidics flow preferably comprises one or several filtration device(s) 205 and/or one or several anti-return device(s) 205. The filtration makes it possible to remove the water remaining in the fluid. In order to carry out this filtration, it is possible for the fluid to return through the reservoir 201 in order for the water remaining in the fluid to be retained in the reservoir 201. The filtration device may comprise at least one bubbler device (or “bubbler” in English). The anti-return device prevents any movement of fluid backwards and/or any return of flames. It comprises a valve, for example.

The fluid, upon its entry into the combustion device 206, preferably comprises only hydrogen and/or oxygen. In order to enter into the combustion device 206, the fluid preferably passes through an injector, an air filter, or an entry collector by way of additional injectors.

Furthermore, the system may comprise ventilators (not depicted) that are arranged to cool the device 1.

Furthermore, the system may comprise a gauge for monitoring the level of fluid in the reservoir 201. Because of this, the dashboard, in the case of a vehicle, can display the level of fluid in the reservoir 201.

In other words, the invention relates to a device 1 for generating hydrogen by electrolysis that is usable without limitation, particularly in the automobile industry, the maritime industry, and the railroad industry. In the generator 1 in accordance with the invention, the fluid is forced to follow a route 100 with ascending and descending movements in order to prevent any separation between the liquid water and the hydrogen and the oxygen created by the electrolysis.

The present invention has been described in relation to specific embodiments, which have a purely illustrative value and must not be considered to be limiting. In a general way, the present invention is not limited to the examples depicted and/or described above. The use of the verbs “comprise”, “include”, “consist” or any other variant, as well as their conjugations, cannot in any way exclude the presence of elements other than those stated. The use of the French indefinite or definite articles used to introduce an element does not exclude the presence of a multiplicity of these elements. The reference numbers in the claims do not limit their scope.

1-16. (canceled)

17. A system comprising:
at least one device for reducing a fuel consumption of a vehicle, wherein the at least one device comprises:
an enclosure;
an inlet for bringing a fluid into the device;
an outlet to release the fluid from the device;
a plurality of conductive plates arranged in the enclosure so as to define compartments,
wherein the plurality of conductive plates comprises, in a first direction:
a first end plate;
intermediate plates; and
a second end plate, and
wherein the plurality of conductive plates comprises, in this order:
the first end plate forming a first anode;
intermediate plates at a floating electric potential;
an intermediate plate forming a first cathode;
intermediate plates at a floating electric potential;
an intermediate plate forming a second anode;
intermediate plates at a floating electric potential; and
the second end plate forming a second cathode; and
alternating lower openings and upper openings arranged to allow a flow of a fluid between the inlet and the outlet, wherein a fluidic passage between two consecutive compartments is possible only through one or more lower openings or through one or more upper openings, and wherein the lower openings are offset from the upper openings in a second direction perpendicular to the first direction so that, when the second direction is a vertical direction, when the fluid moves up in a compartment, the fluid moves down in the next compartment;
a pump arranged to circulate a fluid between the inlet and the outlet;
an electricity supply device connected to the anodes and to the cathodes;
a combustion device; and
a fluidic communication means connecting the outlet to an inlet of the combustion device.

18. The system according to claim 17, wherein the lower openings and the upper openings comprise holes passing through the intermediate conductive plates.

19. The system according to claim 17, wherein the lower openings and the upper openings comprise a hole passing through the first end plate and a hole passing through the second end plate.

20. The system according to claim 17, wherein the lower openings and the upper openings are slits.

21. The system according to claim 20, wherein each of the conductive plates comprises a single slit only.

22. The system according to claim 20, wherein the slits are formed across between 70% and 95% of a width of a conductive plate.

23. The system according to claim 17, wherein two consecutive conductive plates are kept apart by a gasket or a spacer.

24. The system according to claim 17, wherein all of the conductive plates of the plurality of conductive plates are rectangular in shape and elongated in the second direction.

25. The system according to claim 17, wherein all of the conductive plates of the plurality of conductive plates are made of the same material.

26. The system according to claim 25, wherein the fluidic communication means comprises a filtration device.

27. The system according to claim 26, wherein the fluidic communication means comprises a backflow preventing device.

28. A vehicle comprising the system according to claim 17.

29. The vehicle comprising the system according to claim 17, wherein the second direction is vertical.

30. A method for generating hydrogen comprising:
providing a system according to claim 17;
supplying fluid to the inlet of the at least one device and circulating the fluid between the inlet and the outlet of the at least one device; and
applying a potential difference between the first anode and the first cathode, and between the second anode and the second cathode.

31. The system according to claim 21, wherein the slits are formed across between 70% and 95% of a width of a plate.

32. A method for generating hydrogen comprising:
providing a vehicle according to claim 28;
supplying fluid to the inlet of the at least one device and circulating the fluid between the inlet and the outlet of the at least one device; and
applying a potential difference between the first anode and the first cathode, and between the second anode and the second cathode.

33. The system according to claim 25, wherein all of the conductive plates of the plurality of conductive plates are made of metal.

34. The system according to claim 33, wherein all of the conductive plates of the plurality of conductive plates are made of stainless steel, platinum, or gold.

35. A device for reducing a fuel consumption of a vehicle, wherein the device comprises:
an enclosure;
an inlet for bringing a fluid into the device;
an outlet to release the fluid from the device;
a plurality of conductive plates arranged in the enclosure so as to define compartments,
wherein the plurality of conductive plates comprises, in a first direction:
a first end plate;
intermediate plates; and
a second end plate, and
wherein the plurality of conductive plates comprises, in this order:
the first end plate forming a first anode;
intermediate plates at a floating electric potential;
an intermediate plate forming a first cathode;
intermediate plates at a floating electric potential;
an intermediate plate forming a second anode;
intermediate plates at a floating electric potential; and
the second end plate forming a second cathode; and
alternating lower openings and upper openings arranged to allow a flow of a fluid between the inlet and the outlet, wherein a fluidic passage between two consecutive compartments is possible only through one or more lower openings or through one or more upper openings, and wherein the lower openings are offset from the upper openings in a second direction perpendicular to the first direction so that, when the second direction is a vertical direction, when the fluid moves up in a compartment, the fluid moves down in the next compartment.

36. A system comprising:
at least one device comprising:
an enclosure;
an inlet for bringing a fluid into the device;
an outlet to release the fluid from the device;
a plurality of conductive plates arranged in the enclosure so as to define compartments,
wherein the plurality of conductive plates comprises, in a first direction:
a first end plate;
intermediate plates; and
a second end plate, and
wherein the plurality of conductive plates comprises, in this order:
the first end plate forming a first anode;
intermediate plates at a floating electric potential;
an intermediate plate forming a first cathode;
intermediate plates at a floating electric potential;
an intermediate plate forming a second anode;
intermediate plates at a floating electric potential; and
the second end plate forming a second cathode; and
alternating lower openings and upper openings arranged to allow a flow of a fluid between the inlet and the outlet, wherein a fluidic passage between two consecutive compartments is possible only through one or more lower openings or through one or more upper openings, and wherein the lower openings are offset from the upper openings in a second direction perpendicular to the first direction so that, when the second direction is a vertical direction, when the fluid moves up in a compartment, the fluid moves down in the next compartment;
a pump arranged to circulate a fluid between the inlet and the outlet; and
an electricity supply device connected to the anodes and to the cathodes.
